(19) United States
(12) Patent Application Publication
(10) Pub. No.: US 2012/0134190 A1
(43) Pub. Date: May 31, 2012

(54) IMAGE FORMING APPARATUS AND CONTROL METHOD THEREOF

(75) Inventors: Sang-kyu LEE, Seoul (KR); Gu-dal Kwon, Suwon-si (KR)

(73) Assignee: Samsung Electronics Co., Ltd., Suwon-si (KR)

(21) Appl. No.: 13/193,994

(22) Filed: Jul. 29, 2011

(30) Foreign Application Priority Data
Nov. 26, 2010 (KR) 10-2010-0118843

(51) Int. Cl. H02M 7/02

(52) U.S. Cl. 363/100

(57) ABSTRACT

An image forming apparatus includes an image forming unit which forms an image, a power supply which converts input alternating current (AC) power and outputs direct current (DC) power having a predetermined level to operate the image forming unit; a mechanical power switch through which the AC power is supplied and/or shut off, a switch circuit unit which includes a soft power switch to select a turned-on status and/or a turned-off status in accordance with a user's handling, and outputs a switch signal corresponding to a status of the soft power switch, a power controller which selectively supplies the DC power from the power supply to the image forming unit on the basis of the switch signal, and a discharging circuit unit which discharges remaining power of the power supply if the AC power is shut off by the mechanical power switch. Accordingly, a user may quickly turn on/off power using a power switch, and mistaken malfunction may be prevented.

### CROSS-REFERENCE TO RELATED APPLICATIONS

This application claims priority from under 35 U.S.C. §119(a) Korean Patent Application No. 10-2010-0118843, filed on Nov. 26, 2010 in the Korean Intellectual Property Office, the disclosure of which is incorporated herein by reference.

### BACKGROUND OF THE INVENTION

1. Field of the Invention

The present general inventive concept relates to an image forming apparatus and a control method thereof, and more particularly, to an image forming apparatus provided with a mechanical power switch and a soft power switch to be turned on/off, and a control method thereof.

2. Description of the Related Art

An image forming apparatus, such as a printer, a facsimile, a multifunction peripheral, or the like, is provided with a power supply such as a switched mode power supply (SMPS) to supply power. Such a power supply receives alternating current (AC) power and converts it to thereby supply direct current (DC) power having a predetermined level. Also, to turn on/off the power in accordance with a user's handling, the image forming apparatus includes not only a mechanical power switch to switch on/off input of the AC power, but also a soft power switch to switch on/off supply of the DC power.

Meanwhile, an output terminal for the DC power in the power supply is provided with a capacitor having considerable capacity for stabilizing an output voltage. However, in the case where a user turns off the power using the soft power switch and then immediately turns on the power using the mechanical power switch, remaining power changed in the capacitor of the power supply may cause the image forming apparatus to be not properly turned on. In this case, to turn on the power properly, a user has to wait until the capacitor of the power supply is discharged (e.g., for several to ten minutes), which is very inconvenient for him/her. If a user does not comprehend such a situation, they may mistake it as failure in the image forming apparatus.

### SUMMARY OF THE INVENTION

Accordingly, one or more exemplary embodiments provide an image forming apparatus and a control method thereof, in which a user may quickly and smoothly turn on/off power using a power switch.

Additional features and utilities of the present general inventive concept will be set forth in part in the description which follows and, in part, will be obvious from the description, or may be learned by practice of the general inventive concept.

Another exemplary embodiment is to provide an image forming apparatus and a control method thereof, in which mistaken malfunction is prevented when a user turns on/off power using a power switch.

The foregoing and/or other features may be achieved by providing an image forming apparatus including an image forming unit which forms an image, a power supply which converts input alternating current (AC) power and outputs direct current (DC) power having a predetermined level to operate the image forming unit, a mechanical power switch through which the AC power is supplied and/or shut off, a switch circuit unit which includes a soft power switch to select a turned-on status and/or a turned-off status in accordance with a user's handling, and outputs a switch signal corresponding to a status of the soft power switch, a power controller which selectively supplies the DC power from the power supply to the image forming unit on the basis of the switch signal, and a discharging circuit unit which discharges remaining power of the power supply if the AC power is shut off by the mechanical power switch.

The power controller may shut off the DC power supplied to the image forming unit on the basis of the switch signal before the AC power is shut off, and the power supply may resume supply of the DC power by receiving the AC power again through the mechanical power switch after the remaining power is discharged.

The image forming apparatus may further include a zero-cross sensor which senses a zero-point of a waveform that the AC power has and outputs a sensing signal, wherein the discharging circuit unit discharges the remaining power of the power supply on the basis of the sensing signal.

The image forming apparatus may further include a delay circuit which outputs the sensing signal of the zero-cross sensor delayed for a predetermined period of time to the discharging circuit unit.

The discharging circuit unit may include a resistor including one end connected to an output terminal of the DC power of the power supply, and a switching device which is connected between the other end of the resistor and ground and turned on/off in accordance with levels of the sensing signal.

Another feature may be achieved by providing a control method of an image forming apparatus that includes: an image forming unit which forms an image, a power supply which converts input alternating current (AC) power and outputs direct current (DC) power having a predetermined level to operate the image forming unit, a mechanical power switch through which the AC power is supplied and/or shut off, a switch circuit unit which includes a soft power switch to select a turned-on status and/or a turned-off status in accordance with a user's handling, and outputs a switch signal corresponding to a status of the soft power switch, and a power controller which selectively supplies the DC power from the power supply to the image forming unit on the basis of the switch signal, the control method including: forming an image by supplying the DC power to the image forming unit, and discharging remaining power of the power supply if the AC power is shut off by the mechanical power switch.

The control method may further include shutting off the DC power supplied to the image forming unit on the basis of the switch signal before the AC power is shut off, and resuming reception of the AC power and supply of the DC power through the mechanical power switch after the remaining power is discharged.

The control method may further include sensing a zero-point of a waveform that the AC power has and outputting a sensing signal, wherein the discharging the remaining power includes discharging the remaining power of the power supply on the basis of the sensing signal.

The control method may further include delaying the sensing signal for a predetermined period of time, wherein the discharging the remaining power includes discharging the remaining power of the power supply on the basis of the delayed sensing signal.

In another feature of the present general inventive concept, a power control system to operate an image forming unit of an image forming apparatus includes a mechanical power switch to at least one of deliver AC power and inhibit AC power, a switch circuit unit to select at least one of a turned-on state and a turned-off state, and that outputs a switch signal in response to selecting the turned-on state, a power controller that detects when AC power is delivered and inhibited, and that selectively delivers DC power to the image forming unit in response to the switch signal, and a discharging circuit unit that discharges remaining power of the power supply in response to inhibiting the AC power.

In still another feature of the present general inventive concept, a power control system to control power in an image forming apparatus operable in a soft power-off state and a power-on state includes a power converting module to receive a first power and to convert the first power into a second power, a power output module that outputs a third power based on the second power in response to being activated, and a control module that detects a transition from the soft power-off state to the power-on state and that activates the power output module to output the third power when the power converting module receives the first power.

In yet another feature of the present general inventive concept, a method of controlling power in an image forming apparatus operable in a soft power-off state and a power-on state includes detecting a period of time when the image forming apparatus transitions from the soft power-off state to the power-on state, determining whether AC power generated by a power supply is supplied to the image forming apparatus in response to detecting the transition from the soft power-off state to the power-on state, delivering the AC power along a first circuit path when the transition from soft power-off state to the power-on state occurs after the AC power is supplied to the image forming apparatus for a predetermined period of time, and delivering AC power from the power supply along a second circuit path different from the first circuit path when the transition from the soft power-off state to the power-on state occurs before supplying the AC power to the image forming apparatus to discharge remaining power stored in the power supply.

### BRIEF DESCRIPTION OF THE DRAWINGS

These and/or other features and utilities of the present general inventive concept will become apparent and more readily appreciated from the following description of the embodiments, taken in conjunction with the accompanying drawings of which:

FIG. 1 is a block diagram illustrating a configuration of an image forming apparatus according to an exemplary embodiment;

FIG. 2 is a circuit diagram partially illustrating a configuration of a power supply shown in FIG. 1;

FIG. 3A is a block diagram illustrating an exemplary configuration of a power controller illustrated in FIG. 1;

FIG. 3B is a circuit diagram showing an exemplary configuration of a power controller illustrated in FIGS. 1 and 3A;

FIG. 4 is a circuit diagram illustrating an exemplary configuration of a switch circuit unit illustrated in FIG. 1;

FIG. 5 is another exemplary embodiment of the power controller illustrated in FIG. 1;

FIG. 6 is a circuit diagram illustrating a zero-cross sensor according to an exemplary embodiment;

FIG. 7 shows an example of a waveform of a sensing signal according to an exemplary embodiment;

FIG. 8 is a circuit diagram illustrating an exemplary configuration of a discharging circuit unit according to an exemplary embodiment;

FIG. 9 shows an example of an output signal of a delay circuit according to an exemplary embodiment; and

FIG. 10 is a flowchart showing a control method of an image forming apparatus according to an exemplary embodiment.

### DETAILED DESCRIPTION

Reference will now be made in detail to exemplary embodiments of the present general inventive concept, examples of which are illustrated in the accompanying drawings, wherein like reference numerals refer to the like elements throughout. The exemplary embodiments are described below in order to explain the present general inventive concept while referring to the figures.

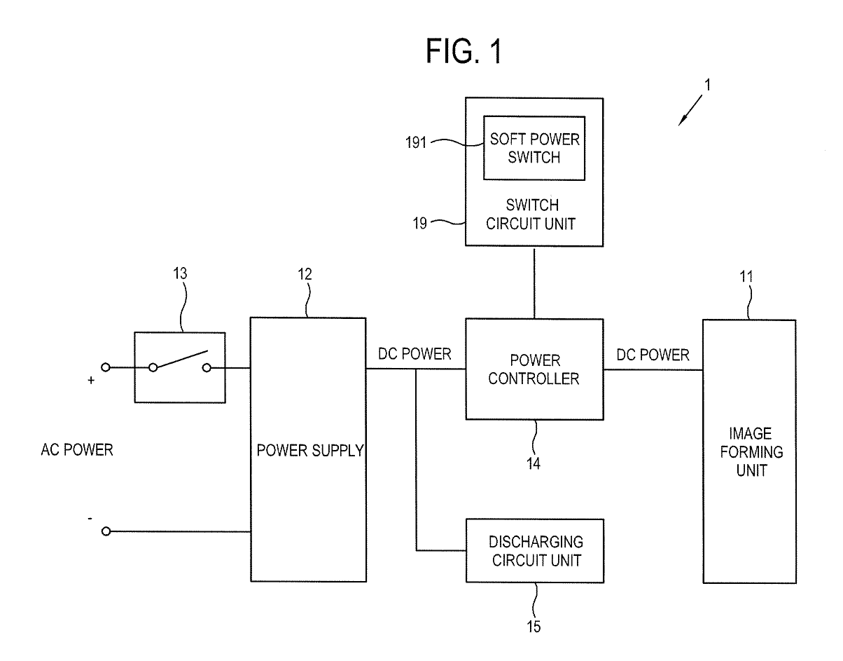

FIG. 1 is a block diagram showing a configuration of an image forming apparatus according to an exemplary embodiment. The image forming apparatus 1 may be achieved by a printer, a facsimile, a multifunction peripheral, etc., which forms an image on a printing medium such as paper. The image forming apparatus 1 is generally discussed below.

As shown in FIG. 1, the image forming apparatus 1 includes an image forming unit 11, a power supply 12, a mechanical power switch 13, a switch circuit unit 19, a power controller 14, and a discharging circuit unit 15. The image forming unit 11 forms an image on a printing medium. There are various types of image forming unit 11 including, but not limited to, a laser type, an inkjet type, etc. to form an image.

The power supply 12 receives and converts AC power and outputs DC power having a predetermined voltage level needed to operate the image forming unit 11 and/or one or more auxiliary control modules (not shown). The DC power output from the power supply 12 may be referred to as a “first DC power,” and may have various levels such as 5V, 3.3V, 24V, etc. Further, the power supply 12 may output one DC power and/or plural DC power. The mechanical power switch 13 is turned on and/or off so as to selectively input the AC power to the power supply 12 in accordance with a user's handling.

The switch circuit unit 19 includes a soft power switch 191 that is manipulated in response to a user's handling, and outputs a switch signal (nPOWER_SW) based on a status of the soft power switch 191. The switch signal (nPOWER_SW) may be output as a “low” signal or a “high” signal. For example, the switch signal (nPOWER_SW) may be output having a voltage at approximately 0V such that the switch signal (nPOWER_SW) is realized as being a “low” signal, and may be output having a voltage at approximately 5V such that the switch signal (nPOWER_SW) is realized as being a “high” signal. It is appreciated, however, that the voltages of the switch signal (nPOWER_SW) described above are merely exemplary, and different voltages may be utilized.

The power controller 14 detects the switch signal (nPOWER_SW) from the soft power switch 191, and selectively delivers the DC power output from the power supply 12 to the image forming unit 11 on the basis of the switch signal. For convenience, the DC power output by the power controller 14 to the image forming unit 11 may be referred to as a “second DC power.” The discharging circuit unit 15 discharges the power remaining in the power supply 12 if the AC power is shut off, e.g., if the AC power is disconnected by the mechanical power switch 13.

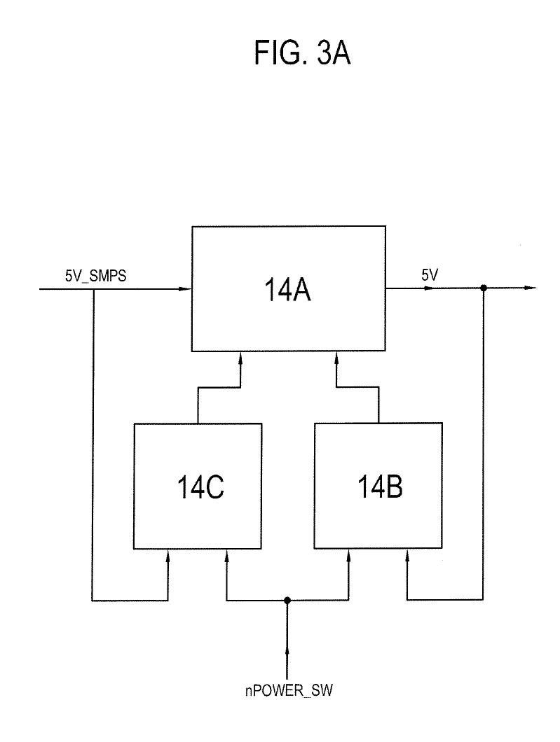

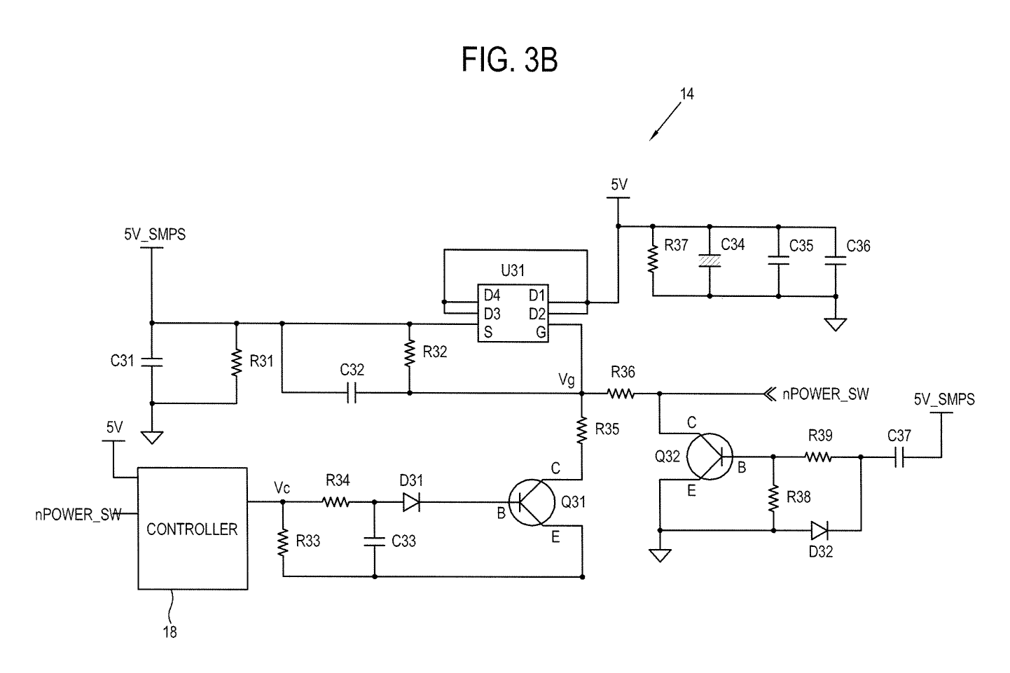

Also, the image forming apparatus 1 may further include a main controller (refer to “18” in FIG. 3) to generally control the image forming unit 11 and/or one or auxiliary control modules. The main controller 18 may be achieved by an application-specific integrated circuit (ASIC) provided with a central processing unit (CPU), an input/output (I/O) controller, etc. Additionally, the image forming apparatus 1 may further include at least one of a panel unit (not shown) to receive a user's handling such as about printing through a key pad, etc.; a display unit (not shown) such as a liquid crystal display (LCD) to display an operating status of the image forming apparatus 1; a non-volatile program memory such as a read only memory (ROM), a flash memory, etc. where a program to be executed by the controller 18 is stored; a volatile main memory such as a random access memory (RAM) in which the program stored in the program memory is temporarily loaded to be executed by the controller 18; a backup memory to back up data such as a phone number, user identification (ID), etc.; a battery to supply power to the backup memory; a scanning unit provided with a charge coupled device (CCD) or a contact image sensor (CIS) to scan an image on the printing medium such as paper or the like; an analog front end (AFE) converting an analog signal output from the scanning unit into a digital signal; an image processor to perform an image process based on data transmitted from the AFE; a line interface unit (LIU) to perform an interface function with a public switched telephone network (PSTN); and a modem unit to modulate and/or demodulate a signal transmitted or received through the LIU.

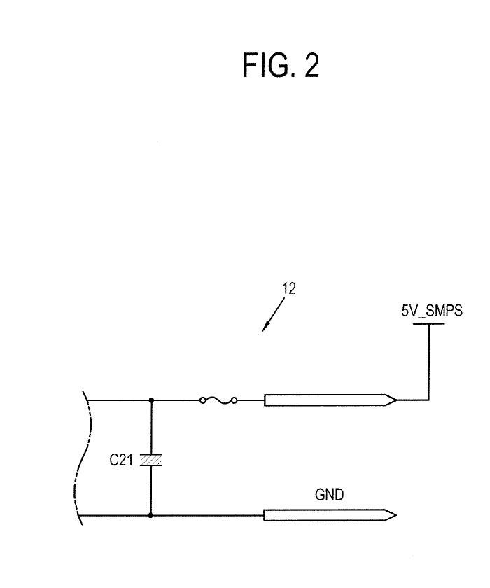

The image forming apparatus 1 will now be discussed in greater detail with reference to FIGS. 2-10. Referring to FIG. 2, a circuit diagram partially illustrates an exemplary embodiment of the power supply 12 of FIG. 1. The power supply 12 may be achieved by a switched mode power supply (SMPS) to convert an input AC power into a DC power, and outputs the DC power. The DC power output from the power supply 12 may be referred to as a first DC power, as mentioned above. In exemplary embodiments hereinafter, the first DC power is indicated as 5V. However, it is appreciated that the voltage of the first DC power is not limited to 5V, and may include different voltage values. Alternatively, the power supply 12 may include a configuration to output a voltage of 3.3V and/or 24V in addition to the first DC power of 5V output from the output terminal (5V_SMPS). To stabilize the first output power, the power supply 12 includes a capacitor C21 is in electrical communication to the output terminal (5V_SMPS) of the power supply 12 that outputs the first DC power. The capacitor C21 may have a predetermined capacitance including, but not limited to, 3300 μF.

Referring now to FIG. 3A, a block diagram illustrating an exemplary embodiment of the power controller 14 of FIG. 1 is shown. The power controller 14 may include a first power control module 14A, a second power control module 14B and a third power control module 14C. The first power control module 14A receives the first DC power output from the output terminal (5V_SMPS) of the power supply 12. Based on the first DC power, the first power control module 14A selectively outputs the second DC power from an output terminal (5V). Further, the first power control module 14A includes a selection control terminal to receive a selection control signals. Based on the selection control signal, the power control module selectively outputs the second DC power. The selection control signal may include first and second selection control signals output from the second and third power control modules 14B, 14C, as discussed further below.

The second power control module 14B is powered according to the second DC power output from the output terminal (5V) of the first power control module 14A. Accordingly, the second DC power from the output terminal (5V) of the first power control module 14A is fedback to the second power control module 14B. Further, the second power control module 14B includes a selector input that receives a switch signal (nPOWER_SW) from the switch circuit unit 19. Based on the second DC power and the switch signal (nPOWER_SW) from the switch circuit unit 19, the second power control module 14B outputs a selection signal (i.e., a first selection control signal). The first selection control signal may be input to the first power control module 14A to selectively control the output of the second DC power, as mentioned above.

The third power control module 14C receives the first DC power output from the output terminal (5V_SMPS) of the power supply 12. In addition, the third power control module 14C receives the switch signal (nPOWER_SW) from the switch circuit unit 19. Based on the switch signal (nPOWER_SW) and whether the first DC power is output by the power supply 12, the third power control module 14C generates a second selection control signal, which may also selectively control the output of the second DC from the first power control module 14A, as discussed in greater detail below.

Referring to FIG. 3B, a circuit diagram illustrating an exemplary embodiment of the power controller 14 of FIGS. 1 and 3A are shown. The power controller 14 receives the first DC power from the power supply 12 at an input terminal (5V_SMPS), and selectively supplies it to the image forming unit 11 and/or one or more auxiliary control modules through an output terminal (5V) connected to drains D1 and D2 of an FET U31. As mentioned above, for convenience, the DC power applied to the input terminal (5V_SMPS) of the power controller 14 will be called “first DC power”, and the DC power output from the output terminal (5V) will be called “second DC power”.

The power controller 14 may further include a plurality of capacitors C34, C35 and C36, and a resistor R37 in electrical communication with the output terminal 5V so as to remove noise. The power controller 14 may further include a resistor R31 and a capacitor C31 provided at an input terminal (5V_SMPS) of the power controller 14. The power controller 14 further includes a field effect transistor (FET) U31 that has a source S connected to the input terminal (5V_SMPS) and drains D1, D2, D3 and D4 connected to the output terminal (5V) at the output side of the FET U31. The FET U31 performs switching to selectively output the second DC power to the output terminal 5V at the output side of the FET U31 based on gate voltages (Vg) realized at the gate (G) of the FET U31. More specifically, the FET U31 may bean n-channel type, which is turned off if the gate voltage Vg is high and turned on if the gate voltage Vg is low. If the FET U31 is turned off, the second DC power is not normally output through the output terminal (5V) at the output side of the FET U31. On the other hand, if the FET U31 is turned on, the second DC power is supplied to the output terminal (5V) via the drains D1, D2, D3 and D4. It is appreciated that the FET U31 may also be a p-channel type FET without changing the general concept described above.

The power controller 14 may further include a capacitor C32 and a resistor R32 connecting the input terminal (5V_SMPS) and the gate G of the FET U31. Also, the gate G of the FET U31 is connected to a collector C of a transistor Q31 via a resistor R35, and is also connected to an output terminal (nPOWER_SW) of the switch circuit unit 19 via a resistor R36. A level of a gate voltage Vg is determined according to whether the transistor Q31 is turned on and/or off and depending on a level (hereinafter, referred to as a “switch signal”) at the output terminal (nPOWER_SW) of the switch circuit unit 19. The transistor Q31 includes an emitter E being grounded, and a base B connected to the output terminal (Vc) to communicate the control signal of the main controller 18 with resistors R33 and R34, a capacitor C33 and a diode D31 therebetween.

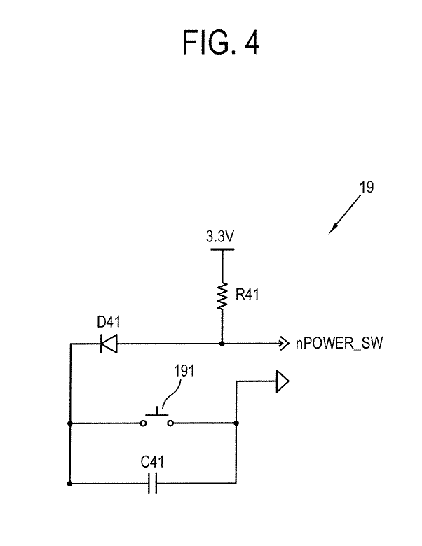

FIG. 4 is a circuit diagram illustrating an exemplary embodiment of the switch circuit unit 19. The switch circuit unit 19 may be provided on the foregoing panel unit to be utilized by a user's handling. The soft power switch 191 is a soft-type switch. The switch may be turned on when a user presses it, and may be turned off when a user releases it. The soft power switch 191 has a first end connected to an operating power via a diode D41 and a resistor R41, and a second end grounded. The operating power may set as 3.3V, however, other voltage values may be used. Although it is not shown, the operating power may be supplied from the power supply 12 or another power supplying means. The switch circuit unit 19 may further include a capacitor C41 connected to both ends of the soft power switch 191. Here, a connection node (nPOWER_SW) between a diode D5 and a resistor R4 is used as an output terminal of the switch signal of the switch circuit unit 19. The switch circuit unit 19 outputs the switch signal (nPOWER_SW) corresponding to the status of the soft power switch 191 in accordance with a user's handling. The switch signal (nPOWER_SW) is high when the soft power switch 191 is in a turned-off status, but low when the soft power switch 191 is in a turned-on status. That is, when a user intends to switch-off power to the image forming apparatus 1, the user may manipulate the soft power switch 191 into the soft power-off status. However, when a user intends to power the image forming apparatus 1, the user may manipulate the soft power switch 191 to initiate the power-on status.

First, a soft power-off status will be described. The soft power-off status may exist when that the mechanical power switch 13 is turned on such that the first DC power is supplied from the power supply 12 to the input terminal (5V_SMPS). However, during the soft power-off status, the main controller 18 may be turned off and does not operate under normal operating conditions, i.e., to control the image forming unit 11 and/or one or more auxiliary control modules. Referring back to FIG. 3, when the image forming unit 11 is turned off during the soft power-off status, the control signal Vc of the main controller 18 is low, and the transistor Q31 is turned off. Also, the soft power switch 191 of the switch circuit unit 19 is in a turned-off status indicating that main controller 18 should be disconnected. Accordingly, when the switch circuit unit 19 is in the turned-off status, the switch signal (nPOWER_SW) output by the switch circuit unit 19 is high, such that the gate voltage Vg of the FET U31 becomes high, and the FET U31 becomes turned off. Thus, the second DC power is not normally supplied through the output terminal (5V) at the output side of the FET U31 of the power controller 14.

Next, a procedure of switching the soft power-off status into a power-on status will be described. In this exemplary embodiment, the power-on status indicates that the main controller 18 is turned on and normally controls the image forming unit 11 and/or one or more auxiliary control modules.

To transition from the soft power-off status into the power-on status, a user presses the soft power switch 191 of the switch circuit unit 19 for a predetermined period of time. After the predetermined period of time elapses, the switch signal (nPOWER_SW) from the switch circuit unit 19 becomes low. As a result, the gate voltage Vg of the FET U31 becomes low. Accordingly, the FET U31 is turned on, so that the second DC power may be normally supplied through the output terminal (5V) at the side of the FET U31 of the power controller 14. Moreover, by switching on the FET U31, the main controller 18 is also initiated, as discussed below.

As shown in FIG. 3, the output terminal (5V) at the output side of the FET U31 of the power controller 14 is also connected to a power input terminal (5V) at the input side of the main controller 18. Accordingly, when the second DC power is normally supplied through the output terminal (5V) at the side of the FET U31 of the power controller 14, the main controller 18 is turned on and starts operating to thereby output a control signal Vc. The control signal Vc may be a high control signal that is realized by the base of the transistor Q31. If the control signal Vc becomes high, the transistor Q31 is turned on. When the transistor Q31 is turned on, the collector C of the transistor Q31 becomes low, and thus the gate voltage Vg of the FET U31 is kept low. Accordingly, the second DC power is continuously supplied through the output terminal (5V) at the output side of the FET U31 of the power controller 14. That is, even if the switch signal (nPOWER_SW) is converted from low to high as a user releases the soft power switch 191 of the switch circuit unit 19, the gate voltage Vg may be continuously kept low by the transistor Q31. In this exemplary embodiment, the resistor R35 and the resistor R36 are respectively designed to make the gate voltage Vg low enough to turn on the FET U31, despite the switch signal (nPOWER_SW) being high and the collector C of the transistor Q31 being low.

Now, a procedure of switching the power-on status into the soft power-off status will be described. As described above, the power-on status indicates that the control signal Vc output from the main controller 18 is high, the transistor Q31 is turned on, the gate voltage Vg of the FET U31 is low, the FET U31 is turned on, and the second DC power is normally supplied through the output terminal (5V) at the output side of the FET U31 of the power controller 14. To turn off the power while operating in the power-on status, a user presses the soft power switch 191 of the switch circuit unit 19 for a predetermined period of time, and then releases it. As a result, the switch circuit unit 19 is transitioned from a turned-on status back into the turned-off status. At a point of time when the soft power switch 192 transitions from the turned-on status into the turned-off status, the switch signal (nPOWER_SW) is converted from low to high. Referring back to FIG. 3, the “high” switch signal (nPOWER_SW) is transmitted to the main controller 18 (see “nPOWER_SW at the side of the main controller 18). When the switch signal (nPOWER_SW) is converted from low to high, the main controller 18 determines that a command to switch the power-on status into the soft power-off status is given. Then, the main controller 18 finishes completing one or more operations being processed, and outputs a low control signal Vc. When the control signal Vc becomes low, the transistor Q31 becomes turned off. If the transistor Q31 is turned off, the collector C of the transistor Q31 becomes high. Accordingly, the gate voltage Vg of the FET U31 becomes high, and the FET U31 is turned off. As a result, the power-on status is switched into the soft power-off status such that the second DC power is not normally supplied through the output terminal (5V) at the output side of the FET U31 of the power controller 14.

The switching operation described above to switch from the soft power-off status to the power-on status, and vice-versa, is not limited to the above method using the soft power switch 191. For example, even though the soft power switch 191 is not handled, the main controller 18 may convert the control signal Vc from high to low in accordance with determination results in the power-on status. For example, a user may not handle the image forming apparatus 1 for a predetermined period of time, so that the image forming apparatus 1 may enter a standby mode. As a result, the switching operation to transition from the power-on status to the soft power-off status may occur, as described above. Inversely, the switching operation from the soft power-off status to the power-on status may occur without depending on the soft power switch 191. For example, a user's handling or another wake-up event may occur in the standby mode. In this case, the main controller 18 converts the controller Vc from low to high, so that the soft power-off status may be switched into the power-on status.

Below, a procedure of switching a hard power-off status into the power-on status will be described. In this exemplary embodiment, the hard power-off status indicates that the AC power is not normally input to the power supply 12. Therefore, the power supply 12 does not normally output the first DC power from the output terminal (5V_SMPS). The hard power-off status may occur when the AC power is not input from the exterior, such as during a power failure, disconnection of a power cord, etc. The hard power-off status may also occur when the mechanical power switch 13 is turned off by a user's handling or the like.

Referring back to FIG. 3, the power controller 14 further includes a transistor Q32 having a collector C that is connected to the gate G of the FET U31 via the resistor R36 in order to switch from the hard power-off status to the power-on status. The transistor Q32 has an emitter E being grounded, and a base B connected to the output terminal (5V_SMPS) of the power supply 12 via a resistor R39 and a capacitor C37 to receive the first DC output voltage. The emitter E and the base B of the transistor Q32 are connected through a resistor R38. A diode D32 is connected between the capacitor C37 and the ground. In the hard power-off status, the first DC power is not generated by the power supply 12. Accordingly, the base B of the transistor Q32 becomes low, and the transistor Q32 is turned off.

However, if the hard power-off status is transitioned into the power-on status such that AC power is input again to the power supply 12, the first DC power is normally supplied from the output terminal (5V_SMPS) of the power supply 12 as, and electric current flows in a moment through the capacitor C37. Accordingly, the base B of the transistor Q32 temporarily becomes high, and the transistor Q32 is turned on. As the transistor Q32 is turned on, the collector C realizes the ground potential and becomes low. Accordingly, the gate voltage Vg of the FET U31 also realizes the ground potential and becomes low. Therefore, the FET U31 is turned on, thereby switching into the power-on status such that the second DC power is normally supplied through the output terminal (5V) at the output side of the FET U31 of the power controller 14. Since the FET U31 begins outputting the second DC power, the capacitor C37 allows DC current to pass therethrough until the capacitor C37 is fully charged. When time elapses enough to fully charge the capacitor C37 with electricity after the transistor Q32 is turned on, the capacitor C37 begins blocking current from flowing therethrough. Accordingly, the base B of the transistor Q32 changes to low and thus the transistor Q32 becomes turned off. However, as described above, since the second DC power may still be delivered by the output (5V) of the FET U31, the transistor Q31 is turned on by the main controller 18 before the transistor Q32 is turned off, so that the FET U31 may be continuously kept turned on.

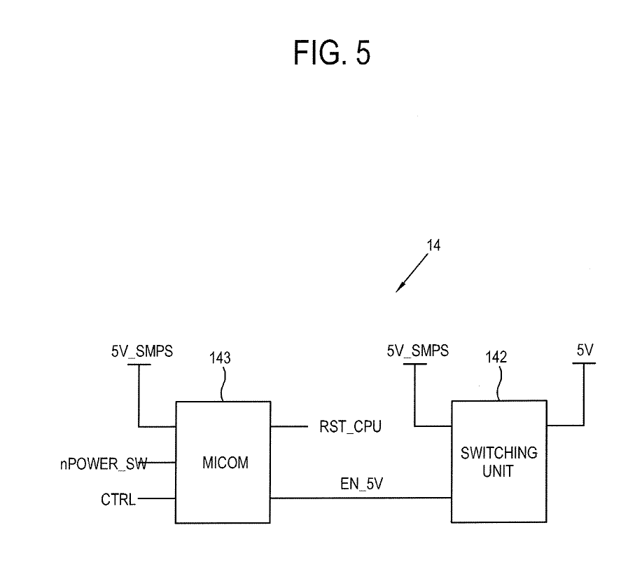

FIG. 5 shows another exemplary embodiment of the power controller shown in FIG. 1. The power controller 14 shown in FIG. 5 includes a switching unit 142 and a microcontroller (MICOM) 143. Like the FET U31 shown in FIG. 3, the switching unit 142 delivers the first DC power output from the power supply 12 and applied to the input terminal (5V_SMPS) to be selectively output as the second DC power output from the output terminal (5V) and supplied to the image forming unit 11 and/or one or more auxiliary control modules.

The MICOM 143 may be a control integrated circuit (IC) provided separately from the main controller 18. The MICOM 143 receives the switch signal (nPOWER_SW), and the first DC voltage output from the output terminal (5V_SMPS) of the power supply 12. Additionally, the MICOM 143 outputs a reset signal (RST_CPU) to the main controller 18, and a switching control signal (EV_{—}5V) to the switching unit 142 to control the switching unit 142 to be turned on/off. Accordingly, the MICOM 143 controls the switching unit 142 on the basis of the switch signal (nPOWER_SW) from the switch circuit unit 19, as discussed below. In addition, an auxiliary control signal (CTRL) may be input to the MICOM 143 to control operation thereof.

The MICOM 143 is operated by the first DC power output from output terminal (5V_SMPS) of the power supply 12. When the switch circuit unit 19 operates in the soft power-off status, the switch signal (nPOWER_SW) is high and the switching unit 142 is turned off, so that the second DC power may not be supplied through the output terminal (5V). If, while operating in the soft power-off status, the switch signal (nPOWER_SW) changes from high to low, the MICOM 143 outputs the switch control signal (EN_{—}5V) so that the switching unit 142 may be turned on. Thus, the second DC power is normally supplied through the output terminal (5V). At the same time, the MICOM 143 outputs a reset signal (RST_CPU) to the main controller 18 so that the main controller 18 may normally operate.

On the other hand, if, while operating in the power-on status, the switch signal (nPOWER_SW) changes from low to high (e.g., when the soft power switch 191 is pressed and then released), the MICOM 143 outputs the switch control signal (EN_{—}5V) so that the switching unit 142 may be turned off. Thus, the second DC power is not normally supplied through the output terminal (5V). Simultaneously, the MICOM 143 outputs a reset signal (RST_CPU) to the main controller 18 so that the main controller 18 may finish one or more operations being processed.

In the meantime, since the first DC power is not supplied from the output (5V_SMPS) of the power supply 12 to the MICOM 143 while in the hard power-off status, the MICOM 143 is turned off. Thereafter, if the AC power is input again during the hard power-off status, the first DC power is normally supplied from the output terminal (5V SMPS) of the power supply 12 such that the MICOM 143 is turned on and starts operating. Then, the MICOM 143 outputs the reset signal (RST_CPU) to the main controller 18 while outputting the switch control signal (EN_{—}5V) to switch on the switching unit 142, so that the main controller 18 may operate normally. Accordingly, the switching operation from the hard power-off status to the power-on status may be achieved.

Below, the discharging circuit unit 15 will be described according to an exemplary embodiment. As described above referring to FIGS. 3 and 5, the power controller 14 performs the switching operation from the hard power-off status to the power-on status according to whether the first DC power is normally output from the output terminal (5V_SMPS) of the power supply 12. More specifically, the power controller 14 according to at least one exemplary embodiment shown in FIGS. 3 and 5 starts the switching operation when the first DC power is not initially output from the output terminal (5V_SMPS) of power supply 12, but is then switched on to normally output the first DC power. That is, the power controller 14 transitions from the hard power-off status to the power-on status in response to detecting when the level of the first DC power output from the output terminal (5V_SMPS) of the power supply 12 changes from low to high.

However, as shown in FIG. 2, the output terminal (5V_SMPS) of the power supply 12 is provided with the capacitor C21 having a considerable capacity. Thus, if the hard power-off status lasts for a considerable amount of time until the capacitor C21 is fully discharged, the output terminal (5V_SMPS) of the power supply 12 may become low. In this status, if the supply of AC power is resumed as the mechanical power switch 13 is turned on or by the like reason, the output terminal (5V_SMPS) of the power supply 12 may change from low to high, so that the power controller 14 may perform the switching operation normally. However, if a transition into the power-on status is performed not long and/or immediately after entering the hard power-off status, the power remaining in the capacitor C21 causes the output terminal (5V_SMPS) of the power supply 12 not to become low, so that the power controller 14 may not normally switch to the power-on status.

For example, in the soft power-off status a user may turn off and then immediately turned on the mechanical power switch 13 in order to turn on the image forming apparatus. In this case, the capacitor C21 starts discharging at the time when the mechanical power switch 13 is turned off. However, if the capacitor C21 does not fully discharge when the mechanical power switch 13 is turned on again, the output terminal (5V_SMPS) of the power supply 12 continuously keeps high. Accordingly, the power controller 14 may not transition from the hard power-off status into the power-on status to perform the switching operation, as mentioned above.

Addressing these concerns, the discharging circuit unit 15 quickly discharges the remaining power from the capacitor C21 provided in the output terminal (5V_SMPS) when the hard power-off status is initiated, i.e., when the AC power is shut off and/or inhibited from being sent to the power supply 12. More specifically, even though the mechanical power switch 13 is turned off and then immediately turned on while the switch circuit unit 19 exists in the soft power-off status, the output terminal (5V_SMPS) of the power supply 12 quickly becomes low by delivering the remaining voltage discharged from the capacitor C21 to the discharging circuit unit 15. After the remaining voltage is discharged to the discharge unit 15, the output terminal (5V_SMPS) changes to high, so that the power controller 14 may transition from the hard power-off status to the power-on status to normally perform the switching operation.

The discharging circuit unit 15 may operate in response to detecting a zero-crossing of the AC input signal. More specifically, the image forming apparatus 1 may further include a zero-cross sensor 16 in electrical communication with the discharge unit 15 to sense whether the AC power is shut off. Accordingly, the discharging circuit unit 15 may operate according to whether the AC power is shut off.

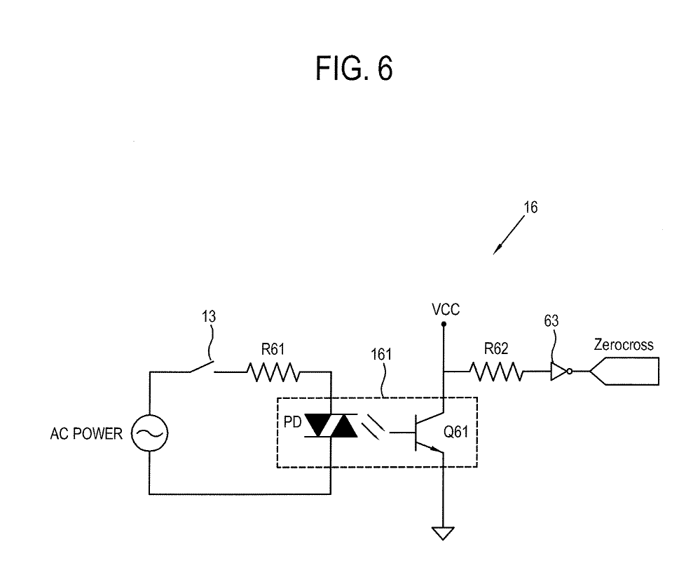

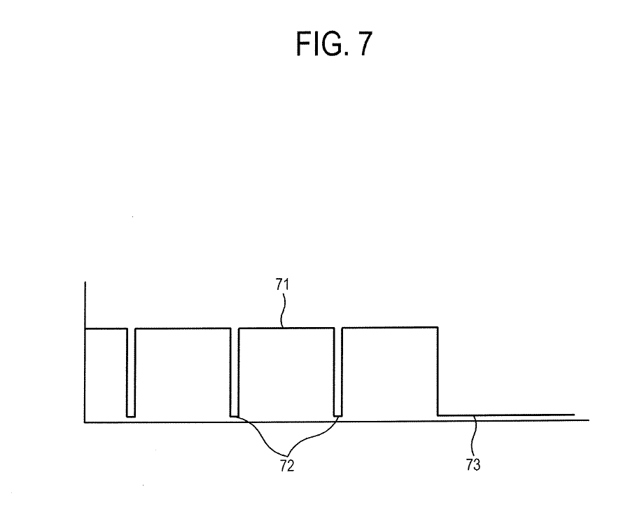

Referring to FIG. 6, a circuit diagram of a zero-cross sensor 16 according to an exemplary embodiment is illustrated. The zero-cross sensor 16 comprises a photo coupler 161 including a photodiode (PD) that emits light in response to electrical current flowing therethrough, and a transistor Q61 that switches between an active and inactive state in response to the light emitted by the photodiode PD. The photodiode PD is connected to the mechanical power switch 13 through a resistor R61. The collector of the transistor Q61 may be connected to a control voltage source (VCC) and a first end of resistor R62, while the emitter may be connected to a ground reference. The second end of resistor R62 may be connected to an inverter 63 such that the sensing signal illustrated in FIG. 7 is generated. Although the exemplary embodiment of FIG. 6 illustrates the transistor Q61 as an ‘npn’ type, it is appreciated, that another type of transistor, such as a ‘pnp’ type transistor, may be used to achieve the general concept described above.

When the AC power is input and the mechanical power switch 13 is turned on, electric current that alternates having a sinusoidal waveform flows in the photodiode PD. As electric current flows in the photodiode PD, the photodiode PD emits light. On the other hand, if electric current does not flow in the photodiode PD, photodiode PD emits no light. In other words, if the photodiode PD is in either section of (+) or (−), the photodiode PD emits light. When the AC power is 0, that is, at a zero point of the waveform the AC power, the photodiode PD emits no light. If the photodiode PD emits light, the transistor Q61 is turned on and outputs a sensing signal (i.e., zero-crossing) of ‘high’. If the photodiode PD emits no light, the transistor Q61 is turned off and outputs a sensing signal (zero-crossing) of ‘low’. FIG. 7 shows an example of the waveform of the sensing signal according to an exemplary embodiment. In FIG. 7, a reference numeral of ‘71’ indicates a section where the sensing signal (i.e., zero-crossing signal) is high, and a reference numeral of ‘72’ indicates a section where the sensing signal (zero-crossing) is low. When the AC power is not input from the exterior, or if the mechanical power switch 13 is turned off, no electric current flows in the photodiode PD, and therefore there is a section where the sensing signal (zero-crossing) is low for a predetermined period of time (refer to ‘73’ in FIG. 7). When, the sensing signal (zero-crossing) is low for a predetermined period of time, the discharging circuit unit 15 determines that the AC power is shut off, and thus quickly discharges the remaining power from the capacitor C21 provided in the output terminal (5V_SMPS) of the power supply 12.

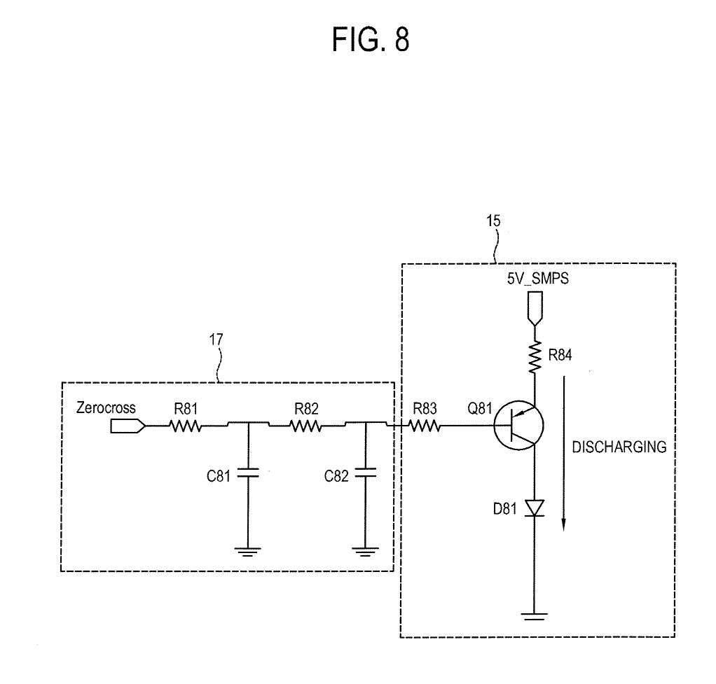

Referring again to FIG. 8, a circuit diagram of the discharging circuit unit 15 according to an exemplary embodiment is illustrated. The discharging circuit unit 15 includes a ‘pnp’ type transistor Q81 switching on the basis of the sensing signal (zero-crossing) output by the zero-cross sensor 16. More specifically, the transistor Q81 includes a base to receive the sensing signal in either a high or low state. The transistor Q81 also includes an emitter connected to one end of a resistor R84, and a collector grounded via a diode D81. The opposite end of the resistor R84 is connected between the output terminal (5V_SMPS) of the power supply 12 and the input of the power controller 14. If the zero-cross sensor 16 does not detect a zero-crossing of the AC signal, the sensing signal received at the base is low, and the transistor Q81 is turned off. However, if the zero-cross sensor 16 detects a zero-crossing of the AC signal, the sensing signal received at the base is high, and the transistor Q81 is turned on. Accordingly, the discharge voltage from the capacitor C21 may be completely discharged to ground via the diode D81 before the output terminal (5V_SMPS) of the power supply 12 returns to a high state, and the power controller 14 is transitioned from the hard power-off status into the power-on status to normally perform the switching operation.

The image forming apparatus 1 may further include a delay circuit 17, as illustrated in FIG. 8, which may disposed between the zero-cross sensor 16 and the discharging circuit 15. The delay circuit 15 receives the sensing signal (i.e., zero-crossing signal) from the zero-cross sensor 16, and outputs the sensing signal to be delayed for a predetermined period of time. The delay circuit 17 may be achieved by a low-pass filter. For example, the low pass filter may include resistors R81 and R82 and capacitors C81 and C82. Further, a resistor R83 may be provided between the delay circuit 17 and the base of the transistor Q81. A delay time (Tdelay) of the delay circuit 17 may be determined as follows.

Tdelay=R*C [Equation 1]

where, R is serial resistance of the resistors R81 and R82, and C is parallel capacitance of the capacitor C81, and C82.

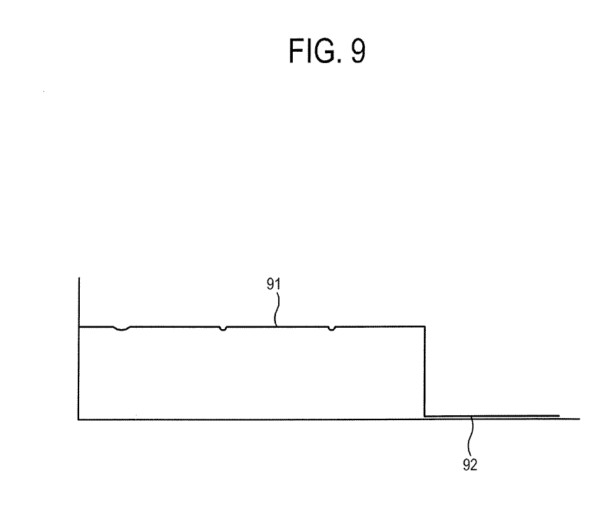

A signal passed through the delay circuit 17 continuously keeps high when the AC power is input (refer to ‘91’ in FIG. 9), and becomes low at a moment when the AC power is shut off (refer to ‘92’ in FIG. 9). Thus, the transistor Q81 remains switched on if receiving the AC power, but immediately becomes switched off at a moment when the AC power is shut off, thereby discharging the remaining power from the capacitor C21.

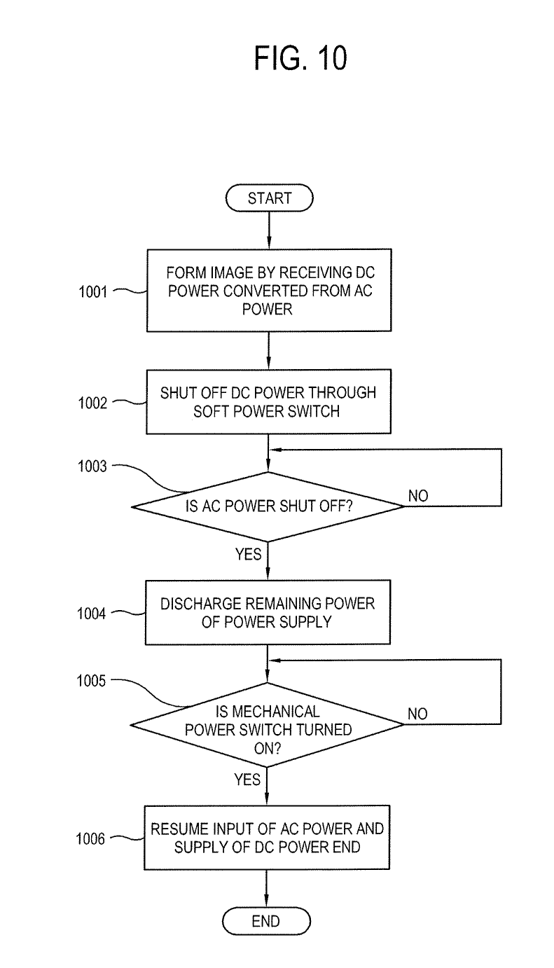

FIG. 10 is a flowchart showing a control method of the image forming apparatus 1 according to an exemplary embodiment. First, at operation 1001, the image forming apparatus 1 forms an image while receiving the DC power converted from the AC power and having a predetermined level. In this case, the image forming apparatus 1 is in the power-on status. Then, at operation 1002, if a user presses the soft power switch 191 to turn off the power in the power-on status, the DC power is shut off and thus the image forming apparatus 1 enters the soft power-off status. Next, at operation 1003, it is determined whether the AC power is shut off in the soft power-off status. If a user turns off the mechanical power switch 13 with an intention to immediately turn on the mechanical power switch 13 again in order to turn on the image forming apparatus, the AC power is shut off. As the AC power is shut off, at operation 1004 the remaining power is discharged from the capacitor 21 connected to the output terminal (5V_SMPS) of the power supply 12. At operation 1005, it is ascertained whether a user turns on the mechanical power switch 13 as following handling to turn on the power with the mechanical power switch 13. At operation 1006, if the mechanical power switch 13 is turned on, the AC power is input again and converted into the DC power, thereby resuming the supply of the DC power.

The present general inventive concept can also be embodied as computer-readable codes on a computer-readable medium. The computer-readable medium can include a computer-readable recording medium and a computer-readable transmission medium. The computer-readable recording medium is any data storage device that can store data as a program which can be thereafter read by a computer system. Examples of the computer-readable recording medium include read-only memory (ROM), random-access memory (RAM), CD-ROMs, DVDs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains

As apparent from the above description, there are provided an image forming apparatus and a control method thereof, in which a user may quickly and smoothly turn on/off power using a power switch.

Also, mistaken malfunction is prevented when a user turns on/off power using a power switch.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An image forming apparatus comprising:
an image forming unit that forms an image;
a power supply that converts input alternating current (AC) power and outputs direct current (DC) power having a predetermined level to operate the image forming unit;
a mechanical power switch to at least one of supply the AC power and shut off the AC power;
a switch circuit unit that comprises a soft power switch to select at least one of a turned-on status and a turned-off status in accordance with a user's handling, and that outputs a switch signal corresponding to a status selected by the soft power switch;
a power controller that selectively supplies the DC power from the power supply to the image forming unit based on the switch signal; and
a discharging circuit unit that discharges remaining power of the power supply when the AC power is shut off by the mechanical power switch.

2. The image forming apparatus according to claim 1, wherein the power controller shuts off the DC power supplied to the image forming unit based on the switch signal before the AC power is shut off, and
the power supply resumes supply of the DC power by receiving the AC power again through the mechanical power switch after the remaining power is discharged.

3. The image forming apparatus according to claim 1, further comprising a zero-cross sensor that senses a zero-point of a waveform that the AC power has and outputs a sensing signal,
wherein the discharging circuit unit discharges the remaining power of the power supply based on the sensing signal.

4. The image forming apparatus according to claim 3, further comprising a delay circuit that outputs the sensing signal of the zero-cross sensor delayed for a predetermined period of time to the discharging circuit unit.

5. The image forming apparatus according to claim 3, wherein the discharging circuit unit comprises:
a resistor comprising one end connected to an output terminal outputting the DC power of the power supply; and
a switching device that is connected between the other end of the resistor and ground to be switched at least one of on and off based on levels of the sensing signal.

6. A control method of an image forming apparatus that comprises: an image forming unit that forms an image; a power supply that converts input alternating current (AC) power and outputs direct current (DC) power having a predetermined level to operate the image forming unit; a mechanical power switch to at least one of supply the AC power and shut off the AC power; a switch circuit unit that comprises a soft power switch to select at least one of a turned-on status and a turned-off status in response to a user's handling, and outputs a switch signal based on a status of the soft power switch; and a power controller that selectively supplies the DC power from the power supply to the image forming unit based on the switch signal, the control method comprising:
forming an image by supplying the DC power to the image forming unit; and
discharging remaining power of the power supply when the AC power is shut off by the mechanical power switch.

7. The control method according to claim 6, further comprising
shutting off the DC power supplied to the image forming unit based on the switch signal before the AC power is shut off; and
resuming reception of the AC power and supply of the DC power based on the mechanical power switch after the remaining power is discharged.

8. The control method according to claim 6, further comprising sensing a zero-point of a waveform that the AC power has and outputting a sensing signal,
wherein the discharging the remaining power comprises discharging the remaining power of the power supply based on the sensing signal.

9. The control method according to claim 8, further comprising delaying the sensing signal for a predetermined period of time,
wherein the discharging the remaining power comprises discharging the remaining power of the power supply based on the delayed sensing signal.

10. A power control system to operate an image forming unit of an image forming apparatus, the power control system comprising:
a mechanical power switch to at least one of deliver AC power and inhibit AC power;
a switch circuit unit to select at least one of a turned-on state and a turned-off state, and that outputs a switch signal in response to selecting the turned-on state;
a power controller that detects when AC power is delivered and inhibited, and that selectively delivers DC power to the image forming unit in response to the switch signal; and
a discharging circuit unit that discharges remaining power of the power supply in response to inhibiting the AC power.

11. A power control system to control power in an image forming apparatus including an image forming unit and operable in a soft power-off state and a power-on state, the power control system comprising:
a power converting module to receive a first power and to convert the first power into a second power;
a power output module that outputs a third power to the image forming unit based on the second power in response to being activated; and
a control module that detects a transition from the soft power-off state to the power-on state and that activates the power output module to output the third power when the power converting module receives the first power.

12. The power control system of claim 11, further comprising a discharging circuit unit in electrical communication with the power output module to selectively deliver the second power to the power output module based on an output of the first power.

13. The power control system of claim 12, wherein the discharging circuit unit selects a first circuit path to deliver the second power to the power output module and selects a second circuit path different from the first circuit path to discharge remaining power stored in the power converting module.

14. The power control system of claim 13, wherein the discharging circuit unit selects the second circuit path when the first power is inhibited from the power converting module and the transition from the soft power-off state to the power-on state is detected.

15. The power control system of claim 13, wherein the discharging circuit selects the first circuit path in response to detecting the transition from the soft power-off state to the power-on state after the first power is received by the power converting module for a predetermined period of time.

16. The power control system of claim 12 further comprising a power detection circuit in electrical communication with the power converting module and the discharging circuit to detect inputting the first power to the power output module and to detect inhibiting the first power to the power output module.

17. The power control system of claim 16, wherein the power detection circuit includes a zero-crossing detection circuit that detects a zero-crossing of the first power and that generates a zero-crossing signal indicating the first power is inhibited in response to detecting the zero-crossing for a predetermined period of time.

18. The power control system of claim 11, wherein the control module controls at least one auxiliary control module in response to detecting the transition from the soft power-off state to the power-on state.

19. The power control system of claim 13, wherein the control module detects a transition from the power-on state to a soft power-off state, and deactivates the power output module to inhibit outputting the third power in response to detecting the transition from the power-on state to the soft power-off state.

20. The power control system of claim 11, wherein the first power is an AC power, the second power is a first DC power, and the third power is a second DC power.

21. A method of controlling power in an image forming apparatus operable in a soft power-off state and a power-on state, the method comprising:
detecting a period of time when the image forming apparatus transitions from the soft power-off state to the power-on state;
determining whether AC power generated by a power supply is supplied to the image forming apparatus in response to detecting the transition from the soft power-off state to the power-on state;
delivering the AC power along a first circuit path when the transition from the soft power-off state to the power-on state occurs after the AC power is supplied to the image forming apparatus for a predetermined period of time; and
delivering AC power from the power supply along a second circuit path different from the first circuit path when the transition from the soft power-off state to the power-on state occurs before supplying the AC power to the image forming apparatus to discharge remaining power stored in the power supply.
